(19) United States
(12) Patent Application Publication
(10) Pub. No.: US 2025/0074751 A1
(43) Pub. Date: Mar. 6, 2025

(54) HOIST SETTING METHOD AND HOIST

(71) Applicant: KITO CORPORATION, Yamanashi (JP)

(72) Inventor: Kazuhiro NISHIKAWA, Yamanashi (JP)

(73) Assignee: KITO CORPORATION, Yamanashi (JP)

(21) Appl. No.: 18/715,188

(22) PCT Filed: Dec. 16, 2022
(86) PCT No.: PCT/IB2022/062344

§ 371 Date: Sep. 11, 2024

(30) Foreign Application Priority Data
Dec. 1, 2021 (JP) 2021-195371

(51) Int. Cl. B66D 3/26; G05B 13/04

(52) U.S. Cl. CPC B66D 3/26; G05B 13/041; B66D 2700/025

(57) ABSTRACT

This method for setting a hoist that is equipped with an encoder for detecting the rotation speed of a drive motor and that lifts and lowers an article by rotating a load sheave using a driving force of the drive motor so as to roll up and roll down a load chain, the method comprising: a drive step for driving the drive motor at a constant rotation speed while applying a tensile force to the load chain; a storage step for storing, in a storage means, positional information obtained from the encoder in the drive step and a motor torque command value for controlling the drive motor in association with said positional information; and a speed correction curve calculation step for calculating a speed correction curve for driving the drive motor on the basis of cyclical variations in the motor torque command value stored in the storage step.

### TECHNICAL FIELD

The present invention relates to a hoist setting method and a hoist.

### BACKGROUND ART

Examples of the hoist for lifting up and down a load include an electric chain block as in PTL 1 which includes a servomotor and hoists and lowers a load chain by rotating a load sheave by driving of the servomotor.

### CITATION LIST

### Patent Literature

{PTL 1} WO 2021/079642

### SUMMARY OF INVENTION

### Technical Problem

Incidentally, the engagement between the load sheave and the load chain can be approximated to a polygonal shape, including the configuration disclosed in PTL 1. Therefore, when hoisting and lowering the load chain, the speed of the load chain varies if a distance between a center line of the hanging load chain and a rotation center of the load sheave varies. Further, the variation in the speed and the mechanical configuration of the electric chain block may cause resonance to cause larger vibration.

However, if some mechanical configuration is added in order to prevent the occurrence of the vibration including resonance by suppressing the above variation in the speed, the size and cost increase accordingly, and therefore the addition is unfavorable. Hence, it is discussed to prevent the vibration in terms of control in the initial setting before shipping the hoist (at a manufacturing stage). However, in the case of preventing the vibration in terms of control in the initial setting at the manufacturing stage, it is more preferable to acquire high effect by simpler control.

The present invention has been made in consideration of the above circumstances and has an object to provide a hoist setting method and a hoist capable of suppressing the occurrence of vibration by simple control.

### Solution to Problem

In order to solve the above problem, according to a first aspect of the present invention, there is provided a method for setting a hoist which includes an encoder for detecting rotation of a drive motor, and hoists and lowers a load chain to lift up and down a load by rotating a load sheave by driving the drive motor, the method including: a driving step of driving the drive motor at a constant rotation speed while applying tension to the load chain; a storage step of storing position information obtained from the encoder at the driving step and a motor torque command value for controlling the drive motor in association with the position information into a storage means; and a speed correction curve calculation step of calculating a speed correction curve for correcting a speed command for driving the drive motor based on a cyclic variation in the motor torque command value stored at the storage step.

Further, it is preferable in the above invention that: a load sensor capable of detecting the weight of the load suspended from the load chain is provided; the method further includes a determination step of determining whether vibration of the load is suppressed without exceeding a predetermined threshold value, based on the detected weight by the load sensor when the driving of the drive motor is controlled by the speed command corrected by the speed correction curve calculated at the speed correction curve calculation step; and when it is determined that the predetermined threshold value is exceeded at the determination step, the driving step, the storage step, and the speed correction curve calculation step are executed again.

Further, it is preferable in the above invention that at the speed correction curve calculation step, an initial phase of the speed correction curve is calculated from the position information at a maximum value and/or a minimum value of the motor torque command value.

Further, it is preferable in the above invention that at the speed correction curve calculation step, the speed correction curve is calculated as a sine waveform.

Further, in order to solve the above problem, according to a second aspect of the present invention, there is provided a hoist including an encoder for detecting rotation of a drive motor, and hoisting and lowering a load chain to lift up and down a load by rotating a load sheave by driving the drive motor, the hoist including: a storage means that stores position information obtained from the encoder at the driving of the drive motor and a motor torque command value for controlling the drive motor in association with the position information; a speed correction curve calculation that calculates a speed correction curve for correcting a speed command for driving the drive motor based on a cyclic variation in the motor torque command value stored in the storage means; and a motor control means that corrects the speed command by the speed correction curve calculated by the speed correction curve calculation means and controls the driving of the drive motor.

### Advantageous Effects of Invention

According to the present invention, it becomes possible to provide a hoist setting method and a hoist capable of suppressing the occurrence of vibration by simple control.

### BRIEF DESCRIPTION OF DRAWINGS

FIG. 1 is a side view illustrating the whole configuration of a hoist according to an embodiment of the present invention.

FIG. 2 is a diagram illustrating a control configuration of the hoist illustrated in FIG. 1.

FIG. 3 is a schematic view of a load sheave and a load chain of the hoist illustrated in FIG. 1, (A) illustrating a state where the load chain is most distant from a rotation center, and (B) and (C) illustrating states where the load chain is closest to the rotation center.

FIG. 4 is a flowchart illustrating a setting method of the hoist illustrated in FIG. 1,

FIG. 5 is a graph illustrating the relation between a torque command value and position information obtained from an encoder in the case of driving a drive motor at a constant speed in the hoist illustrated in FIG. 1.

FIG. 6 is a graph illustrating a speed correction curve stored in a high-order command part of the hoist illustrated in FIG. 1.

FIG. 7 is a graph recording a speed command sent from the high-order command part of the hoist illustrated in FIG. 1 to a speed control part, a solid line indicating a speed command corrected by a speed correction curve, and a broken line indicating a speed command not corrected by the speed correction curve (reference speed command).

FIG. 8 is a graph illustrating an example before suppression of vibration and an example after suppression of vibration in the hoist illustrated in FIG. 1, a solid line indicating the relation between time and vibration in the case of driving the drive motor by a speed command (solid line in FIG. 7) applying the present invention, and a broken line indicating the relation between time and vibration in the case of driving the drive motor by a conventional speed command (broken line in FIG. 7).

### DESCRIPTION OF EMBODIMENTS

Hereinafter, a method for setting a hoist 10 and the hoist 10 according to an embodiment of the present invention will be explained based on the drawings.

### 1. Regarding a Configuration of the Hoist 10

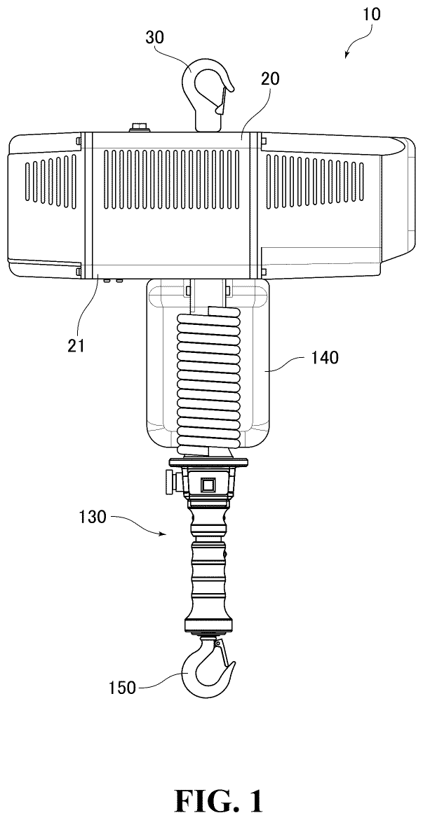

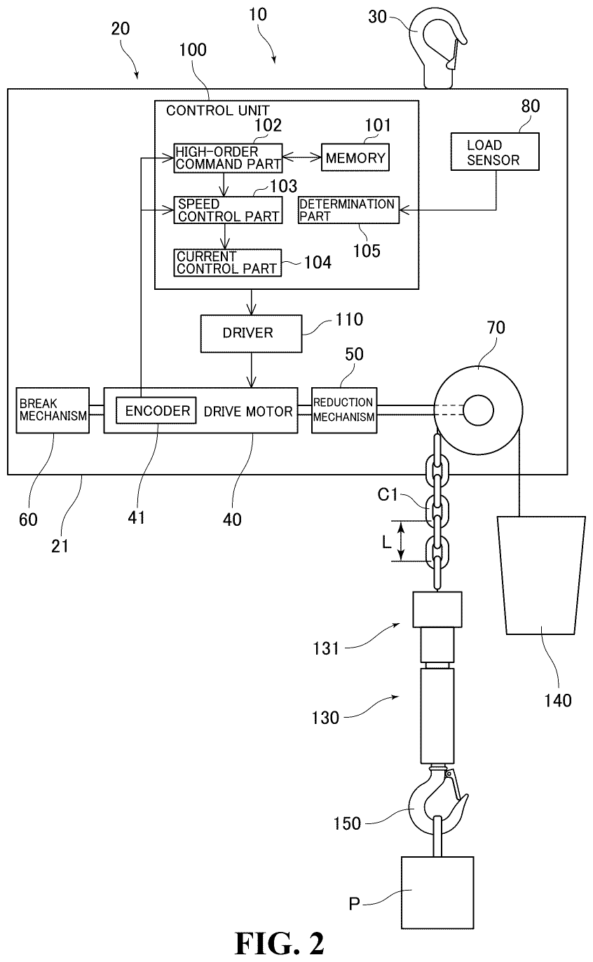

FIG. 1 is a perspective view illustrating the whole configuration of the hoist 10. FIG. 2 is a diagram illustrating a control configuration of the hoist 10. As illustrated in FIG. 1, the hoist 10 has, as main components, a hoist main body part 20, an upper hook 30, a cylinder operation device 130, a chain bucket 140 for holding a hoisted load chain C1, and a lower hook 150. In other words, the hoist 10 in this embodiment is an electric chain block also capable of performing speed control and torque control (current control) of a drive motor 40 by an operation of the cylinder operation device 130.

The hoist main body part 20 can be suspended at a predetermined area such as a ceiling via the upper hook 30. The hoist main body part 20 has various configurations housed inside a housing 21. Specifically, inside the housing 21, the drive motor 40, a reduction mechanism 50, a brake mechanism 60, a load sheave 70 for hoisting the load chain C1, a load sensor 80, a control unit 100, and a driver 110 are provided.

The drive motor 40 is a motor which gives driving force for driving the load sheave 70. In this embodiment, the drive motor 40 is a servo motor including a detector (encoder 41) for reading magnetic pole information, and can detect or calculate speed information and position information from the detector (encoder 41).

Besides, the reduction mechanism 50 is a portion which reduces the rotation of the drive motor 40 and transmits it to the load sheave 70 side, and has a not-illustrated load gear. Besides, the brake mechanism 60 is a portion which releases brake force by electromagnetic force during the operation of the drive motor 40 and generates brake force so as to hold a load P in a state where the drive motor 40 is not operating.

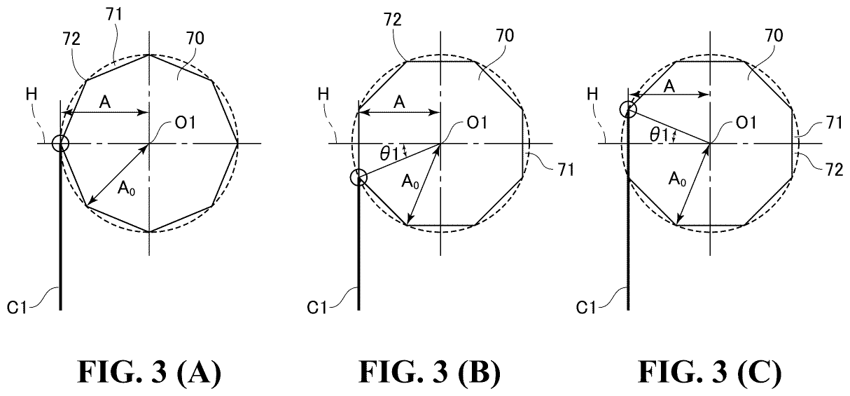

The load sheave 70 is a portion which hoists and lowers the load chain C1, and is provided with a plurality of pockets 71 into which metal rings of the load chain C1 enter along its outer periphery. Here, schematic views of the load sheave 70 are illustrated in FIG. 3(A) to (C). Note that in FIG. 3(A) to (C), only the center line of the load chain C1 is schematically illustrated. As illustrated in FIG. 3(A) to (C), the load sheave 70 is a portion which transmits the driving force of the drive motor 40 to the load chain C1, and has the pockets 71 for transmitting the driving force to the load chain C1 on its outer periphery.

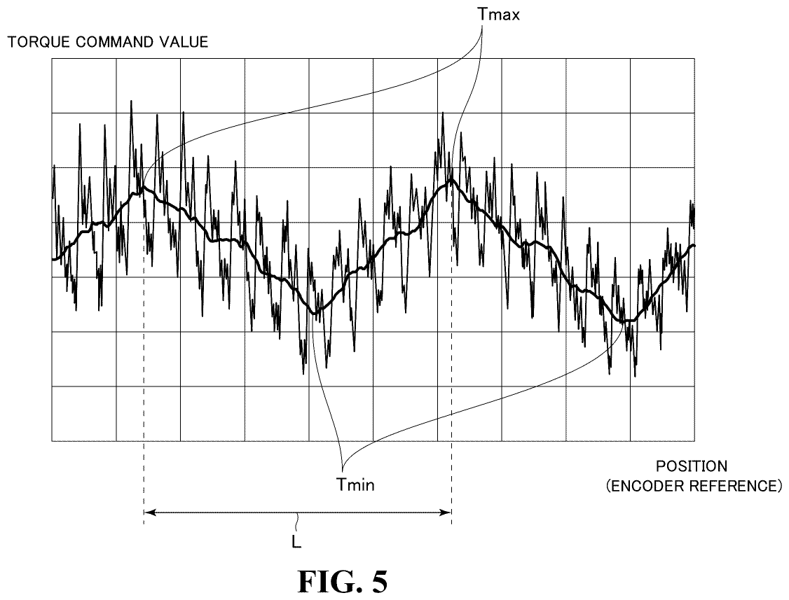

In a not-twisted state of the load chain C1, even-numbered metal rings are orthogonal to odd-numbered metal rings. Therefore, the load sheave 70 is provided with pockets of vertical grooves and horizontal grooves. Accordingly, the load sheave 70 generally has, in the schematic illustration, a hexadecagonal shape, which is made by overlapping two different octagonal shapes such as an octagonal shape formed by linking the center lines of the load chain C1 engaging with the vertical grooves and an octagonal shape formed by linking the center lines of the load chain C1 engaging with the horizontal grooves and which has vertices at intersections of sides. However, in FIG. 3(A) to (C), the load sheave 70 is illustrated in a modeled form, such as one kind of regular octagonal shape with a pitch length L of two metal rings of the load chain C1 (one each of the even-numbered metal ring and odd-numbered metal ring) regarded as one side, from the findings obtained from the actually measured value of a later-explained torque command value illustrated in FIG. 5.

Further, a virtual bent point 72, at which the load chain C1 engages with the load sheave 70 and bends, exists between the adjacent pockets 71 of the load sheave 70. The position of the bent point 72 varies depending on the shape of the load chain C1, the engaging positional relation of the load chain C1 with respect to the load sheave 70, and the tilt during the operation of the hoist 10. Further, it is difficult to assemble the load sheave 70 with a not-illustrated stator of the drive motor 40 with the positional relation (phase) matched. Note that the load sheave 70 is not limited to having a schematic shape of the octagonal shape, but may employ a polygonal shape with a smaller number of angles in the case of desiring downsizing depending on the specifications of the hoist or with a larger number of angles in the case of desiring to reduce the vibration. Further, the pocket 71 may be formed from a locking tooth.

As explained above, the meshing relation between the load sheave 70 and the load chain C1 can be expressed by a regular polygonal shape with the virtual bent points 72 as vertices. As illustrated in FIG. 3(A), in a state where a line linking a center O1 of the load sheave 70 and the bent point 72 is in parallel with a horizontal line H, the load chain C1 exists at a position most distant from the center O1. Further, in this state, a virtual hanging line where the load chain C1 is suspended away from the load sheave 70 at the point of action is most distant from the center O1. Note that the bent point 72 at a region where the load chain C1 engages with or disengages from the load sheave 70 corresponds to a point of action of force. Further, the above hanging line (load chain C1) is also a line of action where the load sheave 70 exerts hoisting force on the hanging load chain C1. In the following explanation, this hanging line is also called a hanging line C1. Further, the distance between the hanging line C1 and the center O1 of the load sheave 70 is called an arm length A regarding rotational torque. Accordingly, the arm length A becomes maximum when the bent point 72 being the point of action of force exists on the horizontal line H as illustrated in FIG. 3(A). The hanging line C1 is not necessarily vertical and coincides with the line of action of force acting on the lower end of the load chain C1. In this case, the horizontal line H can be rephrased as a perpendicular H dropped to the hanging line C1 being the line of action from the center O1.

Note that in a state where the arm length A is maximum, the speed of the load chain C1 with respect to the rotation of the load sheave 70 becomes maximum, and the motor torque of the drive motor 40 also becomes maximum.

On the other hand, as illustrated in FIG. 3(B), (C), when an intersection of a line linking adjacent bent points 72 and the horizontal line H is a center between the adjacent bent points 72, the load chain C1 exists at a position closest to the center O1. In other words, the hanging line C1 is a state of being closest to the center O1 of the load sheave 70, in which state the arm length A becomes minimum. Note that in the state where the arm length A is minimum, the speed of the load chain C1 with respect to the rotation of the load sheave 70 becomes minimum, and the motor torque of the drive motor 40 also becomes minimum. Note that the arm length A in FIG. 3 can be found by the following (Expression 1). Here, A₀ is the distance from the center O1 of the load sheave 70 to the bent point 72.

$$A = {A}_{0} cos θ \qquad ( Expression 1 )$$

As explained above, because the position of the point of action on the load chain C1 by the meshing with the load sheave 70 varies, the speed of the load chain C1 varies even if the drive motor 40 is rotated at a constant speed, and the motor torque of the drive motor 40 also similarly varies. Note that the pitch length L of two metal rings (almost oval links) of the load chain C1 (one each of the even-numbered metal ring and odd-numbered metal ring) coincides with the dimension L of the load chain C1 illustrated in FIG. 2. A pitch circle radius Rp of the load sheave 70 can be expressed by Rp=n·L/2π. n represents the number of angles of the modeled load sheave 70, and Rp=4L/π in the case of the octagonal shape illustrated in FIG. 3. An average speed (reference speed) Va of the lower hook 150 when the load sheave 70 is rotating at a rotation speed ω can be expressed as Va=n·L·ω=2π·Rp·ω.

Returning to the explanation of the configurations of the hoist 10, the load sensor 80 is a load sensor which measures a weight applied to the upper hook 30. In other words, the load sensor 80 is a sensor which measures and detects a total weight of a load of the hoist main body part 20, a weight of the load chain C1 (a portion not landing on the floor or the like), and a weight of the load P. By subtracting a body weight and so on from the total weight measured and detected using the load sensor 80, the weight applied to the load sheave 70 via the load chain C1 can be detected (calculated). The load sensor 80 is attached to an attachment shaft for attaching, for example, the upper hook 30 to the hoist main body part 20. Note that the load sensor 80 corresponds to a load measurement means.

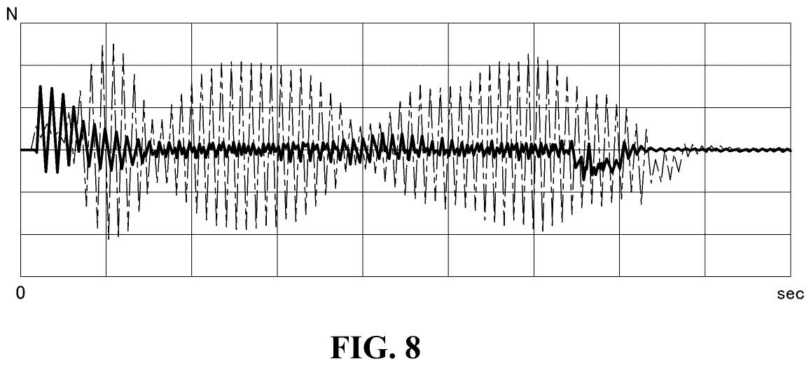

As the load sensor 80, a load cell equipped with a strain gauge can be used. The arrangement position of the load sensor 80 may be any position where the weight applied to the load sheave 70 by the load chain C1 suspending the load P can be detected and measured, such as between the upper hook 30 and a not-illustrated pulley, between the lower hook 150 and the load P, and between the terminal of the load chain C1 and the lower hook 150 in addition to the aforementioned position. Further, for the load sensor 80, a crane scale or the like other can be diverted in addition to the load cell, but it is necessary to be the one having accuracy and responsiveness available for the measurement of dynamic load variation as illustrated in FIG. 8.

Further, the control unit 100 transmits a predetermined control command to the later-explained driver 110. Specifically, the control unit 100 is a portion which gives a command value such as position, speed, and torque. Examples of the control unit 100 include, for example, a computer equipped with a CPU (Central Processing Unit), a memory 101 (RAM (Random Access Memory), ROM (Read Only Memory), an internal storage, an external memory device, or the like), an input/output interface, and so on, and an integrated circuit.

Further, in the control unit 100, a high-order command part 102, a speed control part 103, a current control part 104, and a determination part 105 are functionally realized by the cooperation of hardware included in the control unit 100 and, for example, predetermined program and data stored in the memory 10 and read.

The memory 101 can store position (rotation angle (position) from the origin of the drive motor 40) information obtained from the encoder 41. Further, the memory 101 stores the predetermined program for controlling the drive motor 40 and various kinds of data regarding the control.

Besides, the high-order command part 102 is a portion which transmits a speed command regarding a target speed to the speed control part 103 or transmits a position command regarding a target position. Further, the high-order command part 102 calculates a later-explained speed correction curve (function) and stores the speed correction curve (functions and parameters for calculating the speed correction curve) in the memory 101. The high-order command part 102 further transmits a speed command according to the rotation angle (position) obtained from the encoder 41 to the speed control part 103 based on an operation command from the cylinder operation device 130 and the speed correction curve (functions and parameters for calculating the speed correction curve) read from the memory 101.

Besides, the speed control part 103 is a portion which performs an arithmetic operation for controlling the driving of the drive motor 40 based on the speed command transmitted from the high-order command part 102. Specifically, the speed control part 103 performs, for example, proportional control (P control), integral control (I control), and differential control (D control) in PID control from the speed command being a target speed and the speed information based on the rotation angle (position) obtained from the encoder 41.

Besides, the current control part 104 is a portion which outputs a motor torque command value (current control value) to the driver 110 based on the arithmetic-operated value in the speed control part 103.

Besides, the determination part 105 determines, when the driving of the drive motor 40 is controlled by the speed command corrected by the speed correction curve, whether the vibration of the load P is suppressed without exceeding a predetermined threshold value, based on the weight detection by the load sensor 80. Note that the determination part 105 corresponds to a determination means.

Besides, the driver 110 receives the motor torque command value (current control value) from the current control part 104 and a speed command value, and supplies power based on the drive command value to the drive motor 40. Thus, the drive motor 40 is driven with the controlled power. Note that the control unit 100 and the driver 110 correspond to a motor control means. Note that the control unit 100 includes the speed control part 103 and the current control part 104 and is configured to output the speed command to the driver 110 in FIG. 2, but the driver 110 may be configured to include a speed control part and a current control part. Further, the high-order command part 102 corresponds to a speed correction curve calculation means, but the control unit 100 may correspond to the speed correction curve calculation means.

Here, as is clear from FIG. 2, by feedback of the speed information based on the rotation angle (position) obtained from the encoder 41, the control unit 100 and the driver 110 perform feedback control so that the drive motor 40 reaches the speed commanded by the speed command. This enables the drive motor 40 to follow the speed commanded by the speed command. Note that the encoder 41 outputs a pulse signal accompanying the rotation of the motor, and the control unit 100 converts the pulse signal into speed information and position information and utilizes them for the feedback of the speed control and the position control.

Besides, the cylinder operation device 130 is an operating device for an operator to perform an operation in a state of the operator grasping it by a hand, and is coupled to the lower end side of the load chain C1. The cylinder operation device 130 has an operation switch part 131 into which the operator inputs operation commands, such as switching the operation mode of the hoist 10, a hoisting and lowering command in the rotation direction of the drive motor 40, the speed command, and an emergency stop signal. Further, the cylinder operation device 130 is coupled with the lower hook 150 on which the load P is to be hooked. Note that in place of the operation switch part 131 of the cylinder operation device 130, an operating device (pendant switch) suspended by a cable from the hoist main body part 20 or the like of the hoist 10 may be used, or a wireless remote control device may be used.

Besides, the chain bucket 140 is a portion which houses the load chain C1 on a no-load side (wound) existing on the side opposite to the lower hook 150 across the load sheave 70. Besides, the lower hook 150 is a portion on which the load is to be hooked.

### Regarding the Method for Setting the Hoist 10

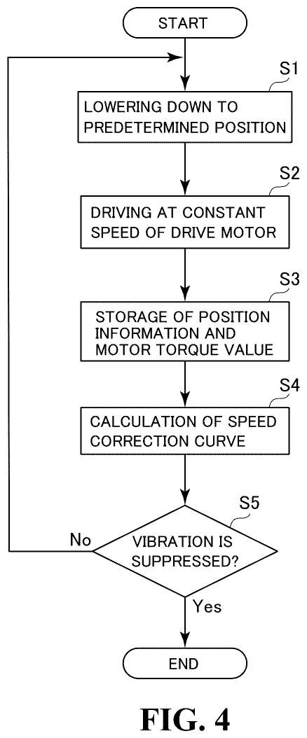

Next, the method for setting the hoist 10 having the above configuration will be explained based on a flowchart in FIG. 4. Note that the method for setting the hoist 10 explained below is related to the initial setting of the hoist 10, and can be applied also to a case other than the initial setting (for example, a setting change during the use of the hoist 10, setting at the time of repair, and so on).

Step S1: Lowering down to a predetermined position

First, the lower hook 150 lifted up to an origin position is lowered down to a predetermined position. In this event, the high-order command part 102 of the control unit 100 outputs a position command for lowering it down to the predetermined position to the speed control part 103, and based on the output, the speed control part 103 outputs a drive command to the driver 110 based on the rotation angle (position) obtained from the encoder 41 to control the drive motor 40 to lower the lower hook 150 down to the predetermined position. A lowering command down to the predetermined position is preferably issued in a manner that the control unit 100 commands a predetermined lowering amount as explained above, but the operator may perform a lowering operation using the operation switch part 131.

Note that the origin in the above is a reference position when the lower hook 150 is lifted up by hoisting, and specifically corresponds to a position where a not-illustrated upper limit switch provided at a lower portion of the hoist main body part 20 is pressed in. Using the origin as a reference makes it possible to calculate a current position (pay-out length of the load chain C1) of the lower hook 150 by the position (rotation angle of the drive motor 40) information obtained from the encoder 41. As explained above, the origin is preferably a position (upper limit position) where the hoist 10 cannot mechanically and controllably hoist it anymore.

Note that after lowering down to the predetermined position, the load P having a predetermined weight is suspended from the lower hook 150. The load P having the predetermined weight can be the one having a weight sufficiently below the rated load, and preferably applies tension at a level of stabilizing the meshing between the load sheave 70 and the load chain C1, to the hanging load chain C1.

Step S2: driving at a constant speed of the drive motor 40 (corresponding to a driving step)

Next, the control unit 100 performs control to drive the drive motor 40 in the hoisting direction to hoist the load. Specifically, the high-order command part 102 of the control unit 100 outputs a speed command for driving the drive motor 40 at a constant very low speed, to the speed control part 103, the speed control part 103 performs an arithmetic operation based on the speed command, and the current control part 104 outputs a predetermined motor torque command value (current control value) to the driver 110 based on the arithmetic operation result. In this event, the speed information on the drive motor 40 based on the rotation angle (position) obtained from the encoder 41 is supplied to the speed control part 103, whereby a feedback control following the speed command (target speed) is performed. The speed command is the rotation speed of the drive motor 40, but may be a speed of the lower hook 150 calculated from a pitch circle diameter of the load sheave 70 and a reduction ratio of the reduction mechanism 50.

Step S3: storage of the position information obtained from the encoder and the motor torque command (corresponding to a storage step)

Further, at the above Step S2, the position information obtained from the encoder 41 and the motor torque command value (current control value) of the drive motor 40 are associated and stored in the memory 101. In the case of the control where the drive motor 40 is feedback-controlled and driven at a constant speed as above, if the load acting on the drive motor 40 varies, the motor torque command value (current control value) given to the drive motor 40 in order to maintain the rotation of the drive motor 40 at a constant speed varies. The varying motor torque command value is associated with the position information obtained from the encoder 41 and stored in the memory 101.

Note that the position information obtained from the encoder 41 corresponds to the rotation number and the rotation angle of the not-illustrated rotor of the drive motor 40, and is information intended to be converted to the pay-out length of the load chain C1 and the position information on the lower hook 150, and the converted value and the motor torque command value are associated and stored in the memory 101. Specifically, the control unit 100 integrates pulse signals from the encoder 41 to convert them into the rotation angle (rotation angle from the origin) of the drive motor 40 being the position information. Note that the position information using the encoder 41 as a reference can be converted into the pay-out length of the load chain C1 or the position information on the lower hook in consideration of the reduction ratio, the shapes of the load sheave 70 and the metal rings constituting the load chain C1, the attachment position and the shape of the upper limit switch, the shape of the lower hook, and so on. Further, the pay-out length of the load chain C1 is calculated using the pitch circle of the load sheave 70 as a reference at Step S3, and the pitch circle of the load sheave 70 is a virtual circle having the length of the load chain C1 hoisted when the load sheave 70 is rotated once, as a circumferential length.

Next, the variation in load torque applied to the drive motor 40 will be explained. When the hanging line C1 being the line of action is most distant from the center O1 of the load sheave 70 as illustrated in FIG. 3(A), the load torque applied to the drive motor 40 becomes maximum and the motor torque command value given to the drive motor 40 becomes maximum.

In contrast to the above, when the hanging line C1 being the line of action is closest to the center O1 of the load sheave 70 as illustrated in FIG. 3(B), (C), the load torque applied to the drive motor 40 becomes minimum and the motor torque command value given to the drive motor 40 becomes minimum.

As explained above, by measuring the motor torque command value (motor torque), it is possible to grasp the variation in load torque applied to the load sheave 70 engaging with the load chain C1. It is known that the motor torque command value cyclically varies due to the meshing positional relation between the load sheave 70 and the load chain C1, which is a variation factor of the hoisting speed of the load chain C1 (moving speed of the lower hook 150). Accordingly, by storing the motor torque command value and the position information obtained from the encoder 41 in association into the memory 101, the meshing positional relation between the load sheave 70 and the load chain C1 can be controlled in association with the position information obtained from the encoder 41 used for the control of the drive motor 40 being a servomotor, and is not affected by the external factor due to the tilt of the hoist 10 or the like.

For example, in a graph illustrated in FIG. 5, a position where the motor torque command value is a maximum value Tmax corresponds to the time when the arm length A is maximum as illustrated in FIG. 3(A). Further, in FIG. 5, a position where the motor torque command value is a minimum value Tmin corresponds to the time when the arm length A is minimum as illustrated in FIG. 3(B), (C).

Note that FIG. 5 is a graph illustrating the relation between the torque command value obtained by driving the modeled load sheave 70 illustrated in FIG. 3 in the hoisting direction at the constant very low speed and the position obtained from the encoder 41, and in this graph, a thin line indicates the motor torque command value stored in the memory 101 in association with the position information, and a thick line indicates a value obtained by performing smoothing processing on the motor torque command value finely varying due to the meshing of not-illustrated gears of the reduction mechanism 50 by a predetermined method such as moving average. Further, FIG. 5 illustrates a positional relation in which the pay-out length of the load chain C1 from the load sheave 70 decreases as going from the left to the right in the graph. The graph in FIG. 5 illustrates two positions indicating the maximum values Tmax and two positions indicating the minimum values Tmin of the motor torque command value. In FIG. 5, the interval between positions indicating the two adjacent maximum values or the interval between positions indicating the two adjacent minimum values can be regarded as a cycle length of the varying waveform. Thus, it has been newly confirmed that the cycle length obtained from FIG. 5 corresponds to the length L of the adjacently coupled two metal rings (a vertical link and a horizontal link) constituting the load chain C1, from the relation of the reduction ratio of the reduction mechanism 50 coupling the drive motor 40 and the load sheave 70. Thus, it has been confirmed that it is more preferable to perform control of suppressing the vibration with the load sheave 70 regarded as a model of a regular polygon (octagon in an example) with the length L of the two metal rings (a vertical link and a horizontal link) as one side than to perform control of suppressing the vibration with the load sheave 70 regarded as a model of a polygon (hexadecagon in an example) with each of metal rings of a vertical link and a horizontal link as one side. Further, the number of metal rings constituting the load chain C1 hoisted by one rotation is constant in the load sheave 70, so that also the phase of the variation waveform at an arbitrary position from the origin can be calculated from this data.

Step S4: calculation of the speed correction curve (corresponding to a speed correction curve calculation step)

Next, a speed correction curve (function) for creating the speed command for suppressing the speed variation of the lower hook 150 is calculated. As explained above, the pockets 71 of the load sheave 70 have a plurality of pockets each having the vertical groove and the horizontal groove as a pair. The length of the load chain C1 hoisted by one rotation of the load sheave 70 can be decided by the number of pockets 71 and the shape sizes of the metal rings (vertical links and horizontal links) constituting the load chain C1. Then, the positional relation engaging with the load sheave 70 with the vertical link and the horizontal link as one set can be approximated to a regular polygonal shape. In this case, the regular polygon is made to have a length of the vertical link and the horizontal link as one set (dimension L of the load chain C1 illustrated in FIG. 2) as the length of one side of the regular polygonal shape. In FIG. 3, the regular polygonal shape is a regular octagon shape.

For the calculation of the speed correction curve, the phase of the variation cycle of the speed and the phase of the variation cycle in the position information are confirmed first from the relation between the position information obtained from the encoder 41 stored at Step S3 and the motor torque command value. The hoisting speed becomes the maximum value at a position where the motor torque value exhibits the maximum value, whereas the hoisting speed becomes the minimum value at a position where the motor torque value exhibits the minimum value.

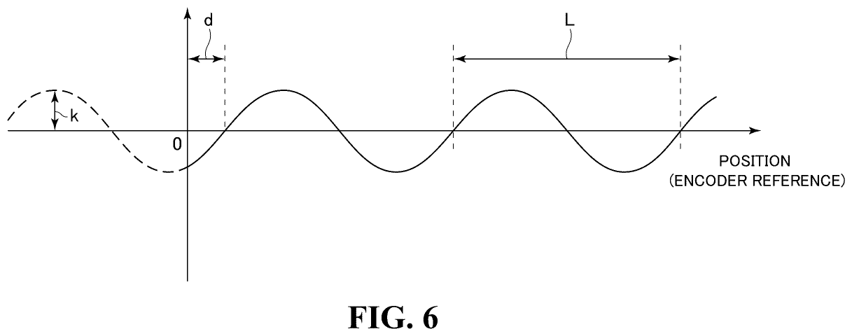

FIG. 6 illustrates a speed correction curve created using a variation component of the speed given to suppress the speed variation of the lower hook 150 in the speed command to be given to the speed control part 103, as a sine waveform. The speed correction curve is created while matching phases of the sine waveforms so that the position exhibiting the minimum value of the motor torque command value illustrated in FIG. 5 and the position exhibiting the maximum value of the speed correction curve coincide with each other or the position exhibiting the maximum value of the motor torque command value and the position exhibiting the minimum value of the speed correction curve coincide with each other. This makes it possible to create a speed command y for reducing the speed variation occurring when the load sheave 70 is driven to hoist the load chain C1, and express it as the following (Expression 2).

$$y = s [ 1 + k \cdot sin \{ ( 2 π / L ) ( x - d ) \} ] \qquad ( Expression 2 )$$

Here, the expression k·sin{(2π/L)(x−d)} is a variation component of the speed given to suppress the speed variation of the lower hook 150 and corresponds to the speed correction curve (function).

Here, signs in the above (Expression 2) are as follows.
s: reference speed
k: variation coefficient
L: cycle length
x: distance from the origin (variable)
d: initial phase

The reference speed s is a speed of the speed command created corresponding to the operation command of the cylinder operation device 130 before the correction, and is a speed created using the pitch circle of the load sheave 70 as a reference. The variation coefficient k is found from the variation in the arm length A. Further, the cycle length L is a length of two metal rings (a vertical link and a horizontal link) constituting the load chain C1. The distance x from the origin is a distance found from the product of the rotation number of the encoder 41 obtained by integration from the origin (corresponding to the rotation angle of the drive motor 40) and the circumferential length of the pitch circle of the load sheave 70 and the reduction ratio, and can be regarded as the pay-out length of the load chain C1. The initial phase d is the phase illustrated in FIG. 6, and indicates the meshing relation between the load sheave 70 and the load chain C1 at the origin using the position information on the encoder 41 as a reference. The speed correction curve is created from one set of the positions of arbitrary two adjacent maximum values or minimum values of the motor torque command value illustrated in FIG. 5, but may be created by statistical procedure from a plurality of sets. The variation coefficient k can be made k=(A₀−Rp)/Rp from the relation between the radius Rp of the pitch circle of the load sheave 70 and the maximum value A₀ of the arm length A regarding the rotational torque of the load sheave 70, and may be decided by repeating actual measurement of the vibration using this value as a reference. The cycle length L, the distance x from the origin, and the initial phase d can be found using the integrated value of the pulse signals of the encoder 41 as a reference, and therefore may be expressed by the number of pulses, or may be expressed by the rotation angle or the rotation number of the drive motor 40 by converting the pulse signals of the encoder 41. Though the product of the reference speed s and the variation coefficient k becomes an amplitude a of the cycle variable component of the speed command after the correction, the amplitude a is decided and then the variation coefficient k may be found.

In the above (Expression 2), the distance x from the origin is a virtual distance when assuming the load sheave 70 to be a circle as explained above, and can be expressed by the following expression.

$$x = n \cdot L \cdot N \qquad ( Expression 3 )$$

n: modeled load sheave angle number
n·L: corresponding to the circumferential length of the pitch circle of the load sheave
N: rotation number of the load sheave from the origin

The distance x from the origin calculated using the pitch circle of the load sheave 70 as a reference is different from the actual pay-out length of the load chain C1, but the pay-out length of the load chain C1 and the position of the lower hook 150 in consideration of the meshing positional relation between the load sheave 70 and the load chain C1 can be accurately calculated by integrating the speed commands y created using (Expression 2).

In the case of controlling the driving of the drive motor 40 by the speed command found by the (Expression 2), the drive motor 40 is not driven at a constant speed but causes cyclic variation in the rotation speed, and the lower hook 150 and the load P are brought into a state of being lifted up with suppressed variation in speed caused by the meshing between the load sheave 70 and the load chain C1 in a polygonal shape.

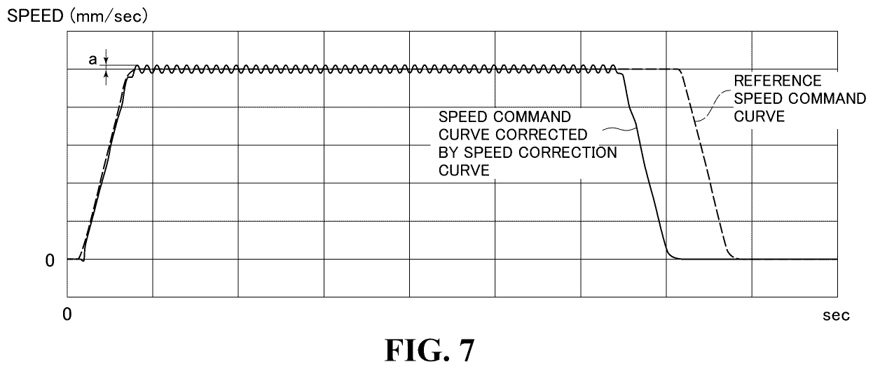

The speed command calculated as above is illustrated in FIG. 7. In FIG. 7, a solid line indicates the speed command corrected by the speed correction curve, and a broken line indicates the conventional speed command (reference speed command) not corrected by the speed correction curve.

Specifically, the graph records the speed commands sent from the high-order command part 102 to the speed control part 103 in the case with speed correction (solid line) and the case without speed correction (broken line) when inputting a high-speed hoisting command into the operation switch part 131 for a predetermined time in a state where the lower hook 150 suspends the load P.

Note that the calculated speed correction curve is stored in the memory 101 as a function and its constant.

Step S5: determination whether the vibration is suppressed or not (corresponding to a determination step)

Next, in the case of drive-controlling the drive motor 40 by the speed command y created using the speed correction curve found at Step S4, whether the vibration at the lower hook 150 is suppressed is determined. Then, if it is confirmed that the vibration is suppressed to fall below the predetermined threshold value of the vibration (in the case of Yes), the calculated speed correction curve is regarded as having no problem, and the initial setting of the hoist 10 for finding the speed correction curve is ended. In contrast to this, if it is confirmed that the vibration exceeds the predetermined threshold value of the vibration (in the case of No), the steps at Steps S1 to S5 are executed again. Alternatively, the value of the variation coefficient k in the speed correction curve (function) created at Step S4 is changed and next Step S5 may be repeatedly executed to decide the optimum variation coefficient k.

Further, an example before suppression of the vibration and an example after suppression of the vibration are illustrated in FIG. 8. FIG. 8 is a graph illustrating the relation between the time and the load by the vibration in the case of driving the drive motor 40 by the speed command corrected by the speed correction curve calculated at Step S4 by a solid line, and illustrating the relation between the time and the load by the vibration in the case of driving the drive motor 40 not by the control when correcting the speed command by the speed correction curve calculated at Step S4 but by the normal speed control at the reference speed s by a broken line. FIG. 8 illustrates graphs of calculating and recording a vibration component (load during the hoisting operation: dynamic load—load immediately before operation: static load) from the load information detected by the load sensor 80 when driven by the respective speed commands.

In the graph illustrated in FIG. 8, the vibration occurring at the lower hook 150 when rotating the load sheave 70 by the driving of the drive motor 40 is suppressed in the case of driving the drive motor 40 by the corrected speed command as indicated by the solid line, as compared with the case of driving the drive motor 40 by the normal speed control at the reference speed s as indicated by the broken line. In other words, it is possible to satisfactorily suppress the vibration of the lower hook 150 (namely, the load P) by controlling the driving of the drive motor 40 by the speed command calculated using the speed correction curve created from the data in which the position information (rotation angle position from the origin of the drive motor 40) obtained from the encoder 41 and the motor torque command are stored in association. Note that at Step S5, whether the correction curve is good or bad is determined by square averaging the vibration component and comparing the resultant with a predetermined threshold value.

### Regarding Effects

The method for setting the hoist which includes the encoder 41 for detecting the rotation of the drive motor 40 and hoists and lowers the load chain C1 to lift up and down the load by rotating the load sheave 70 by driving the drive motor 40, includes: the driving step of driving the drive motor 40 at a constant rotation speed while applying tension to the load chain C1; the storage step of storing the position information obtained from the encoder 41 at the driving step and the motor torque command value for controlling the drive motor 40 in association with the position information into the memory 101 (storage means); and the speed correction curve calculation step of calculating the speed correction curve (function) for correcting the speed command for driving the drive motor 40 based on the cyclic variation in the motor torque command value stored at the storage step.

The above makes it possible to easily calculate the speed correction curve for suppressing the vertical vibration of the lower hook 150 from the cyclic variation in the motor torque command value for each hoist 10 different in reduction ratio of the speed reducer and in pitch length of the load chain C1 in setting the hoist 10 (particularly, in setting at a shipping stage), and the speed command is calculated based on the speed correction curve to control the driving of the drive motor 40. Thus, even if the distance between the center line of the hanging load chain C1 and the rotation center of the load sheave 70 varies and the vibration occurring due to the variation is different for each hoist 10, the speed command is calculated based on the speed correction curve created by measuring the variation in the motor load in advance and the drive motor 40 is driven, thereby making it possible to appropriately suppress the variation in the hoisting speed of the load P and suppress the vibration. Further, when driving the drive motor 40, the vibration in hoisting speed of the lower hook 150 (load P) is appropriately suppressed as above, thereby making it possible to prevent the occurrence of resonance in the hoist 10.

Further, since the speed correction curve is created in advance based on the motor torque command value for suppressing the variation in the speed in a speed control mode of the servomotor and the speed command is calculated based on the speed correction curve to control and drive the drive motor 40 as above, the control of the drive motor 40 for hoisting and lowering at the speed based on the operation command of the operator is simple and another mechanical configuration such as a shock absorber is unnecessary, thereby making it possible to suppress an increase in cost.

Further, in this embodiment, the load sensor 80 capable of detecting the load of the load P suspended from the load chain C1 is provided; the method further includes the determination step of determining whether the vibration of the load P is suppressed without exceeding the predetermined threshold value, based on the detected load by the load sensor 80 when the driving of the drive motor 40 is controlled by the speed command corrected by the speed correction curve calculated at the speed correction curve calculation step S4; and when it is determined that the predetermined threshold value is exceeded at the determination step, at least the speed correction curve calculation step S4 of the lowering step S1, the driving step S2, the storage step S3, and the speed correction curve calculation step S4 is executed again.

Thus, by detecting the actual vibration of the load P by the load sensor 80 by controlling the drive motor 40 based on the speed command corrected by the speed correction curve, the effect of suppressing the vibration can be determined. In the case where the vibration suppression effect is low so that the vibration of the lower hook 150 (load P) exceeds the predetermined threshold value, the speed command curve is found again, and therefore the vibration suppression effect can be surely made high.

Further, in this embodiment, at the speed correction curve calculation Step S4, the initial phase of the speed correction curve is calculated from the position information at the maximum value Tmax or/and the minimum value Tmin of the motor torque command value.

Thus, it is possible to easily calculate the initial phase of the speed correction curve which cyclically varies. Further, since the speed correction curve can be calculated in a state of reflecting the dispersion in an initial phase of each hoist 10, it is possible to effectively prevent the speed from varying during the driving of the drive motor 40 and satisfactorily prevent the occurrence of the vibration on the hoist 10.

Further, in this embodiment, at the speed correction curve calculation Step S4, the speed correction curve is calculated as a sine waveform.

Thus, it is easy to calculate the speed correction curve and it is possible to easily realize the drive control of the drive motor 40 so that the drive motor 40 follows the speed command corrected by the speed correction curve based on the sine wave, and effectively suppress the vibration of the lower hook 150 (load P).

Further, the hoist 10 in this embodiment includes: the memory 101 (storage means) that stores the position information obtained from the encoder 41 at the driving of the drive motor 40 and the motor torque command value for controlling the drive motor 40 in association with the position information; the speed correction curve calculation means that calculates calculates the speed correction curve for correcting the speed command for driving the drive motor 40 based on the cyclic variation in the motor torque command value stored in the memory 101 (storage means); and the control unit 100 and the driver 110 (motor control means) that corrects the speed command by the speed correction curve created by the speed correction curve calculation means to control the driving of the drive motor 40.

Thus, as has been explained, the speed correction curve is calculated in advance using the motor torque command value at the time of driving the drive motor 40 at a constant speed for each hoist 10 different in reduction ratio of the speed reducer and pitch length of the load chain C1 in the setting of the hoist 10 (particularly, in the setting at a shipping stage), to control the driving of the drive motor 40 based on the speed correction curve. Thus, even if the distance (rotation radius) between the center line of the hanging load chain C1 and the rotation center of the load sheave 70 varies and the vibration occurring due to the variation is different for each hoist 10, the speed command is corrected based on the speed correction curve calculated by measuring the variation in the motor load in advance and the drive motor 40 is driven, thereby making it possible to appropriately suppress the variation in the hoisting speed of the load P. Further, when driving the drive motor 40, the variation in hoisting speed of the lower hook 150 (load P) is appropriately suppressed as above, thereby making it possible to prevent the occurrence of resonance in the hoist 10.

Further, since the speed command curve for suppressing the vibration due to the variation in load is calculated by the high-order command part 102 in order to suppress the variation in speed and the drive motor 40 is control-driven based on the speed command curve as above, the control of the drive motor 40 is simple and another mechanical configuration such as a shock absorber is unnecessary, thereby making it possible to suppress an increase in cost.

### Modification Examples

The embodiments of the present invention have been explained above, and the present invention can be variously modified in addition to them. Hereinafter, the modification examples will be explained.

In the above embodiments, the driving of the drive motor 40 is controlled based on the same speed command curve during the driving of the drive motor 40. However, the period from driving to stop of the drive motor 40 is divided into a plurality of sections, and the variation coefficient k of the speed command curve in (Expression 2) may be changed for each section. For example, as illustrated in FIG. 8, the vibration is larger at the activation of the drive motor 40 than in other sections, and the variation coefficient k of (Expression 2) is adjusted in that section, thereby making it possible to further satisfactorily reduce the vibration occurring accompanying the driving of the drive motor 40.

Further, instead of dividing the period from driving to stop of the drive motor 40 into the plurality of sections as above, the variation coefficient k may be any function.

Further, the speed correction curve is calculated as the sine wave in the above embodiments, but may be calculated as a triangular waveform based on the actually measured torque command value. Also in this case, the speed correction curve is created so that the position (rotation angle of the drive motor 40) indicating the minimum value of the motor torque command value and the position (rotation angle of the drive motor 40) indicating the maximum value of the speed correction curve coincide with each other and the position (rotation angle of the drive motor 40) indicating the maximum value of the motor torque command value and the position (rotation angle of the drive motor 40) indicating the minimum value of the speed correction curve coincide with each other. It is preferable that the amplitude of the speed correction curve is calculated based on the change amount in the arm length A accompanying the movement of the rotation angle of the drive motor 40.

Further, the speed correction curve may be calculated based on a curve obtained by turning upside down the curve found by simply smoothing the actually measured torque command value. Also in this case, it is preferable to find the amplitude of the variation waveform based on a difference between the maximum value A₀ of the arm length illustrated in FIG. 3 and the pitch circle radius Rp or a difference between the minimum value of the arm length A and the pitch circle radius Rp with respect to the above reference speed s decided by the pitch circle radius Rp of the load sheave 70.

Further, the hoist 10 in this embodiment is an electric chain block capable of speed control and torque control of the drive motor 40, and the drive motor is preferably a servomotor and preferably includes a drive motor, an encoder, and a drive control device, which can accurately detect the load torque acting on the drive motor due to the meshing positional relation (polygonal action) between the load sheave and the load chain.

Further, though the lowering is performed down to the predetermined position at Step S1 and the motor torque command is stored at Steps S2 to S3, the lowering may be performed for the whole lifting height of the hoist 10 and then the hoisting may be performed for the whole lifting height at Steps S2 to S3 and the motor torque command is stored, and the speed correction curve (function) at the position of the whole lifting height may be calculated and stored in the memory at Step S4.

### REFERENCE SIGNS LIST

10 . . . hoist, 20 . . . hoist main body part, 21 . . . housing, 30 . . . upper hook, 40 . . . drive motor, 41 . . . encoder, 50 . . . reduction mechanism, 60 . . . brake mechanism, 70 . . . load sheave, 71 . . . pocket, 72 . . . bent point, 80 . . . load sensor (corresponding to a load measurement means), 100 . . . control unit, 101 . . . memory (corresponding to a storage means), 102 . . . high-order command part (corresponding to a speed correction curve calculation means), 110 . . . driver (corresponding to a motor control means), 130 . . . cylinder operation device, 140 . . . chain bucket, 150 . . . lower hook, C1 . . . load chain, P . . . load

1. A method for setting a hoist which comprises an encoder for detecting rotation of a drive motor, and hoists and lowers a load chain to lift up and down a load by rotating a load sheave by driving the drive motor, the method comprising:
driving the drive motor at a constant rotation speed while applying tension to the load chain;
storing position information obtained from the encoder at said driving and a motor torque command value for controlling the drive motor in association with the position information into a computer memory storage; and
calculating a speed correction curve for correcting a speed command for driving the drive motor based on a cyclic variation in the motor torque command value stored said storing.

2. The method for setting the hoist according to claim 1, wherein
with respect to a load sensor capable of detecting the weight of the load suspended from the load chain, the method further comprises determining whether vibration of the load is suppressed without exceeding a predetermined threshold value, based on the weight detected by the load sensor under a condition where the driving of the drive motor is controlled by the speed command corrected by the speed correction curve calculated at said calculating the speed correct curve; and
under a condition where said determining determines that the predetermined threshold value is exceeded, at least the driving, the storage, and the speed correction curve calculation is executed again.

3. The method for setting the hoist according to claim 1, wherein
at said calculating the speed correction curve, an initial phase of the speed correction curve is calculated from the position information at a maximum value and/or a minimum value of the motor torque command value.

4. The method for setting the hoist according to claim 1, wherein
at said calculating the speed correction curve, the speed correction curve is calculated as a sine waveform.

5. A hoist comprising:
an encoder to detect rotation of a drive motor, and hoisting and lowering a load chain to lift up and down a load by rotating a load sheave by driving the drive motor;
a computer memory storage that stores position information obtained from the encoder at the driving of the drive motor, and a motor torque command value for controlling the drive motor in association with the position information;
a speed correction curve calculator that calculates a speed correction curve for correcting a speed command for driving the drive motor based on a cyclic variation in the motor torque command value stored in the computer memory storage; and
a motor controller that corrects the speed command by the speed correction curve calculated by the speed correction curve calculator and controls the driving of the drive motor.

6. The method of setting the hoist according to claim 2, wherein
at said calculating the speed correction curve, an initial phase of the speed correction curve is calculated from the position information at a maximum value and/or a minimum value of the motor torque command value.

7. The method of setting the hoist according to claim 2, wherein
at said calculating the speed correction curve, the speed correction curve is calculated as a sine waveform.

8. The method of setting the hoist according to claim 3, wherein
at said calculating the speed correction curve, the speed correction curve is calculated as a sine waveform.
